(19) United States
(12) Patent Application Publication
(10) Pub. No.: US 2011/0292935 A1
(43) Pub. Date: Dec. 1, 2011

(54) RELAY DEVICE, CONTROL INFORMATION GENERATING METHOD, CONTROL AND INFORMATION GENERATION PROGRAM

(75) Inventors: Susumu TANEOKA, Kawasaki (JP); Eiji Sugawara, Kawasaki (JP)

(73) Assignee: FUJITSU LIMITED, Kawasaki-shi (JP)

(21) Appl. No.: 13/111,655

(22) Filed: May 19, 2011

(30) Foreign Application Priority Data
May 26, 2010 (JP) 2010-120998

(51) Int. Cl. H04L 12/28

(52) U.S. Cl. 370/389

(57) ABSTRACT

A relay device includes: a relay to relay a frame transmitted and received between transmission devices as a termination of a transferring path of a piece of data; an information generator to obtain a piece of path identification information for identifying the transferring path and a piece of device identification information for identifying the transmission device and generate a piece of control information based on the obtained piece of path identification information and the piece of device identification information; and an alarm signal transmitter to generate an alarm signal based on the control information generated by the information generator when an error occurs in the transferring path and transmit the generated alarm signal.

### CROSS-REFERENCE TO RELATED APPLICATIONS

This application is based upon and claims the benefit of priority from the prior Japanese Patent Application No. 2010-120998 filed on May 26, 2010, the entire contents of which are incorporated herein by reference.

### FIELD

The embodiments discussed herein are related to a relay device, a control information generating method, and a control information generation program.

### BACKGROUND

Until now, a Synchronous Digital Hierarchy/Synchronous Optical Network (SDH/SONET) transmitting method has been switched to a packet transmitting method as cost of a network of a telecommunication carrier is reduced and the demand of Internet Protocol (IP) traffic is increased. Compared to the SDH/SONET transmitting method, the packet transmitting method has an advantage that the line utilization efficiency is high. However, according to the packet transmitting method, if a Layer 2 Switch (L2SW) is used, for example, path control may not be achieved by a telecommunication carrier. Due to this, the packet transmitting method is not suitable for a high quality carrier grade service.

In recent years, for the packet transmitting method, standardization of Multi Protocol Switch-Transport Profile (MPLS-TP), by which a path is controllable when the telecommunication carrier monitors a state of a network, has been achieved.

For the packet transmitting method, standardization of Operation and Maintenance (OAM) for detecting an error and character deterioration has been achieved by the Institute of Electrical and Electronics Engineers, Inc (IETF). In the OAM of the packet transmitting method, a termination device in a Maintenance Entity Group (MEG) is set as a Maintenance Entity End Point (MEP) in each MEG as a group to be managed.

In the OAM of the packet transmitting method, a relay device in the MEG is set as a Maintenance Entity Intermediate Point (MIP), and a packet for the OAM is used to monitor an error and to transfer an alarm if the error occurs. Here, error monitoring and alarm transferring in the MPLS-TP will be described. FIG. 13 is a diagram illustrating an example of an MPLS-TP network.

As illustrated in FIG. 13, the network includes a node A and a node C as a termination node, and includes a node B as a relay node. The node A includes slots 1-1, 1-5, and 1-6 and is coupled to the node B through the slot 1-5. The node B includes the slots 1-6 and 1-5 and is coupled to the node A through the slot 1-6. The node B is coupled to the node C through the slot 1-5. The node C includes the slots 1-1, 1-5, and 1-6 and is coupled to the node B through the slot 1-6. In this case, an example of the slot is an interface circuit or a network interface card that is coupled to another node.

As illustrated in FIG. 13, for example, in the network, an MEG in which the path from the node A to the node C is to be managed is set. Furthermore, in the network, an MEG in which the section between the node A and the node B is to be managed is set. Moreover, in the network, an MEG in which the section between the node B and the node C is to be managed is set.

In the network, an MEGID and an MEPID are assigned to each of the set MEGs. For example, the MEG, which is set in the section between the node A and the node B, is assigned with “MEPID of node A:11,” “MEPID of node B:12,” and “MEGID:0011.” Similarly, the MEG that is set in the section between the node B and the node C and the MEG that is set in a path from the node A to the node C are assigned with the MEGID and the MEPID, respectively. The “MEGID” and the “MEPID” are identifiers for uniquely identifying “MEG” and “MEP”, respectively.

Based on the MEGID and the MEPID, the node to which the MEP is set transmits a Continuity Check Message (CCM) frame, which is used to check a coupling ability of the corresponding MEP, in a certain period. The node to which the corresponding MEP is set checks the coupling ability between the MEPs by regularly receiving the CCM frame transmitted in the certain period. For example, in the MEG that is set in the section between the node B and the node C, the node B to which the MEP is set checks the coupling ability between the node B and the node C by regularly receiving the CCM frame from the node C in which the corresponding MEP is set.

The MEP transfers the alarm if the MEP does not receive the CCM frames sequentially in a prescribed period. For example, if the node B does not receive the CCM frame in the time of 3.5 periods, the node B determines that the section between the node C and the node B is a Loss of Continuity (LOC) and then transmits an alarm such as an Alarm Indication Signal (AIS). Japanese Laid-open Patent Publication No. 2003-298649 is a related art of the present invention.

### SUMMARY

According to an aspect of the invention, a relay device includes: a relay to relay a frame transmitted and received between transmission devices as a termination of a transferring path of a piece of data; an information generator to obtain a piece of path identification information for identifying the transferring path and a piece of device identification information for identifying the transmission device and generate a piece of control information based on the obtained piece of path identification information and the piece of device identification information; and an alarm signal transmitter to generate an alarm signal based on the control information generated by the information generator when an error occurs in the transferring path and transmit the generated alarm signal.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating a configuration of a relay device according to a first embodiment;

FIG. 2 is a diagram illustrating an example of a network that includes a relay node according to a second embodiment;

FIG. 3 is a diagram illustrating an example of a path OAM format;

FIG. 4 is a diagram illustrating an example of an OAM PDU format;

FIG. 5 is a diagram illustrating an example of a CCM OAM PDU format;

FIG. 6 is a diagram illustrating a configuration of a relay node according to a second embodiment;

FIG. 7 is a diagram illustrating a remote MEP list storage;

FIG. 8 is a diagram illustrating an example of an AIS OAM PDU format;

FIG. 9 is a sequence diagram illustrating a procedure of processing in a network that includes the relay node according to the second embodiment;

FIG. 10 is a diagram illustrating a procedure of generating processing of a remote MEP list by the relay device according to the second embodiment;

FIG. 11 is a diagram illustrating a procedure of transmitting processing of an AIS by the relay node according to the second embodiment;

FIG. 12 is a diagram illustrating a computer that executes a control information generation program;

FIG. 13 is a diagram illustrating an example of an MPLS-TP network; and

FIGS. 14A and 14B are diagrams illustrating transfer of the AIS.

### DESCRIPTION OF EMBODIMENTS

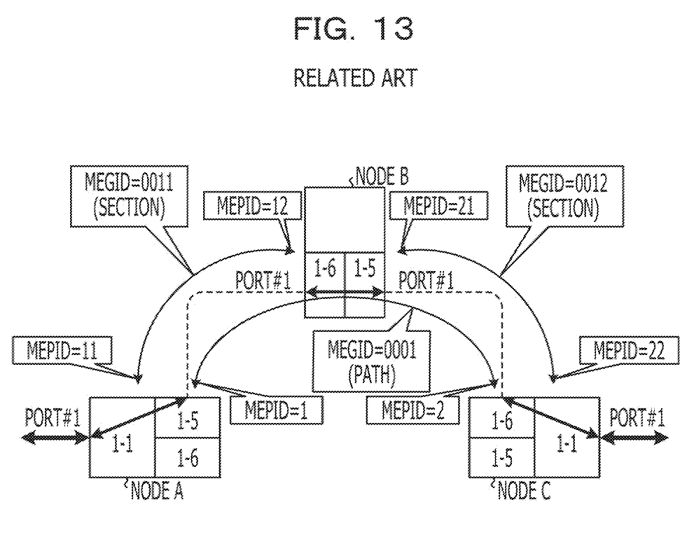

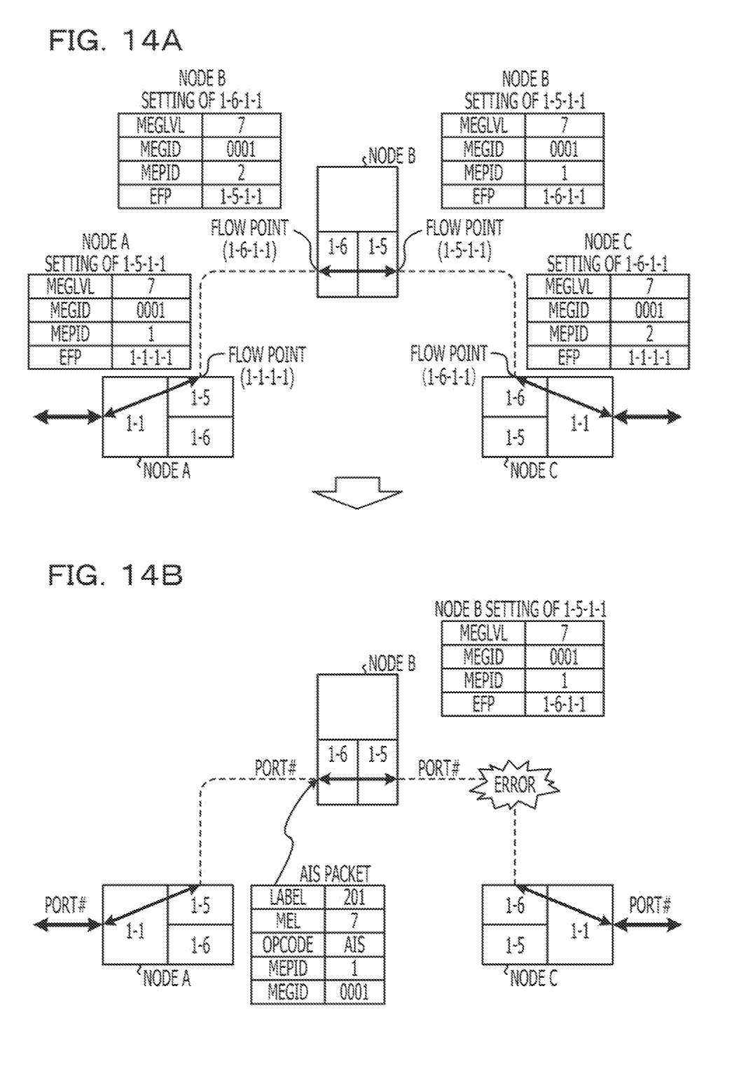

The conventional technique has a problem that load of operation setting on a manager of a network is increased. Specifically, in the conventional technique, an alarm such as an AIS is transferred with reference to the information that is set in advance by the manager of the network. FIGS. 14A and 14B are diagrams illustrating transfer of the AIS. FIGS. 14A and 14B illustrate transfer of the AIS in a case where an error generated in the section between the node B and the node C in the MPSL-TP network illustrated in FIG. 13.

As illustrated in FIG. 14A, information in which an MEG level (MEGLVL), an MEGID, an MEPID, and an Egress flow point (EFP) are associated with each other for each flow point. The MEG level indicates a management level of an MEG. The MEGID indicates an ID of the MEG that is set as a path in which the AIS is transmitted. According to the MEG that is set to as a path from the node A to the node C, the MEPID indicates an ID of the MEP as the transmission destination of the AIS. The EFP indicates a flow point on an outlet side of each node when the AIS is transmitted.

For example, for a flow point 1-5-1-1 of the node B, as illustrated in FIG. 14A, “MEG level:7, MEGID:0001, MEPID:1, EFP:1-6-1-1” is set. The above-described information indicates that the management level of the MEG of “MEGID:0001” is “7.” The above-described information indicates that the node B transmits the AIS to the node A as the MEP of “MEPID:1” if an error occurs in the path from the slot 1-5 of the node B to the slot 1-1 of the node C in the MEG of “MEGID:0001.” The above-described information indicates that the AIS is transmitted in a path from the slot 1-6 of the node B to the slot 1-1 of the node A.

As illustrated in FIG. 14B, if an input break occurs after an error occurs in the section between the node B and the node C, the node B generates an AIS packet with reference to the information that is set to the flow point 1-5-1-1. For example, as illustrated in FIG. 14B, the node B generates an AIS packet indicating “Label:201, OpCode:AIS, MEPID:1, MEGID:0001” and transmits the AIS packet to the node A.

Accordingly, to make each node on the network autonomously transmit an alarm indicating error occurrence, the manager of the network sets the information for each flow point of the node on the network before operation of the network. As a result, the load of the operation setting on the manager of the network is increased.

With reference to the attached diagrams, embodiments of the relay device, the control information generating method, and the control information generation program disclosed in the present application will be described in detail. The relay device, the control information generating method, and the control information generation program disclosed in the present application are not limited to the following embodiments.

[First Embodiment]

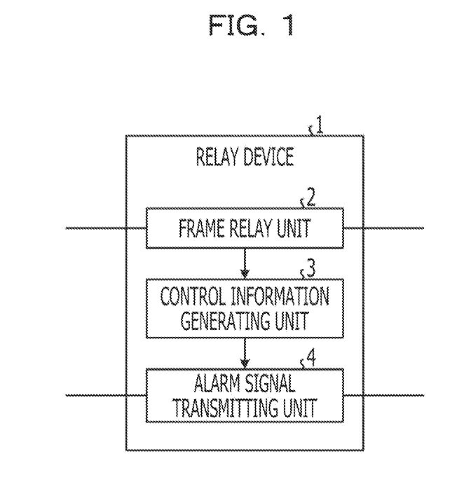

A configuration of a relay device according to a first embodiment will be described. FIG. 1 is a diagram illustrating the configuration of the relay device according to the first embodiment. As illustrated in FIG. 1, a relay device 1 includes a frame relay unit 2, a control information generating unit 3, and an alarm signal transmitting unit 4. The frame relay unit 2 relays a frame that is transmitted and received between transmission devices at the termination of a transmission path of data. The frame relay unit 2 may include a circuit (hardware) that has, for example, an Application Specific Integrated Circuit (ASIC), a Field Programmable Gate Array (FPGA), or the like. The frame relay unit 2 further includes a circuit (hardware) such as a CPU or a memory and may be controlled by a program.

The control information generating unit 3 obtains path identification information for identifying a transfer path and device identification information for identifying a transmission device and then generates control information based on the obtained path identification information and the device identification information. The control information generating unit 3 may include a circuit (hardware) that has, for example, an Application Specific Integrated Circuit (ASIC), a Field Programmable Gate Array (FPGA), or the like. The control information generating unit 3 includes a circuit (hardware) such as a CPU or a memory and may be controlled by a program. If an error occurs in the transmission path, the alarm signal transmitting unit 4 generates an alarm signal based on the control information generated by the control information generating unit 3 and transmits the generated alarm signal. The alarm signal transmitting unit 4 may include a circuit (hardware) that has, for example, an Application Specific Integrated Circuit (ASIC), a Field Programmable Gate Array (FPGA), or the like. The alarm signal transmitting unit 4 includes a circuit (hardware) such as a CPU or a memory and may be controlled by a program.

As described above, the relay device 1 according to the first embodiment obtains the path identification information and the device identification information from the relayed frame. By using the obtained path identification information and device identification information, the relay device 1 generates control information that is to be used to transmit the alarm signal. The relay device 1 according to the first embodiment may autonomously generate the control information that is to be used to transmit the alarm signal even though the manager of the network does not set the control information. As a result, the relay device 1 according to the first embodiment may reduce the load of the operation setting on the manager of the network.

[Second Embodiment]

In a second embodiment, an example of a network that includes a relay node according to the second embodiment will be described. The relay node according to the second embodiment will be described below.

[Configuration of Network that Includes Relay Node According to Second Embodiment]

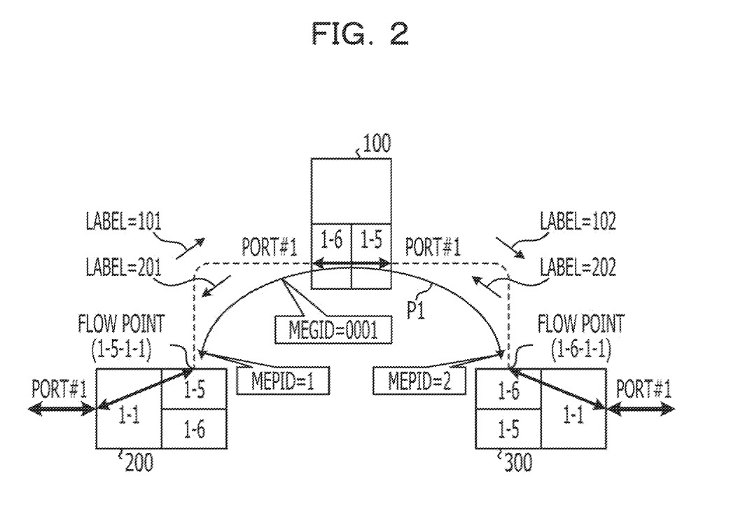

The configuration of the network that includes the relay node according to the second embodiment will be described. FIG. 2 is a diagram of an example of the network that includes the relay node according to the second embodiment. The network includes a relay node 100, a termination node 200, and a termination node 300. The termination node 200 and the termination node 300 are coupled to the relay node 100, respectively.

In this case, the MPLS-TP and the OAM are applied, and a path P1 is provided between the termination node 200 and the termination node 300. In the network, as illustrated in FIG. 2, the termination node 200 is assigned with “MEPID:1,” the termination node 300 is assigned with “MEPID:2,” and the path provided between the termination node 200 and the termination node 300 is assigned with “MEGID:0001.” Even though the diagram is omitted, a section OAM is applied in the section between the termination node 200 and the relay node 100 and in the section between the termination node 300 and the relay node 100, and the MEGID and the MEPID are assigned in the sections, respectively. In this case, the section indicates a section between adjacent nodes that are physically coupled with each other through a transmission path. The path indicates a communication route between arbitrary nodes, and a node may be allocated in the middle of the path.

The termination node 200 transmits a CCM frame, which is used to check the coupling ability, to the corresponding termination node 300 in a certain period. For example, as illustrated in FIG. 2, the termination node 200 transmits the CCM frame attached with “Label:101” from the flow point 1-5-1-1 to the termination node 300. The termination node 200 regularly receives the CCM frame transmitted from the corresponding termination node 300. As illustrated in FIG. 2, for example, the termination 200 regularly receives the CCM frame attached with “Label:201” from the termination node 300.

The termination node 300 transmits the CCM frame to the corresponding termination node 200 in a certain period. For example, as illustrated in FIG. 2, the termination node 300 transmits the CCM frame attached with “Label:200” from the flow point 1-6-1-2 to the termination node 200. The termination node 300 regularly receives the CCM frame transmitted from the corresponding termination node 200. As illustrated in FIG. 2, for example, the termination node 300 regularly receives the CCM frame attached with “Label:102” from the termination node 200.

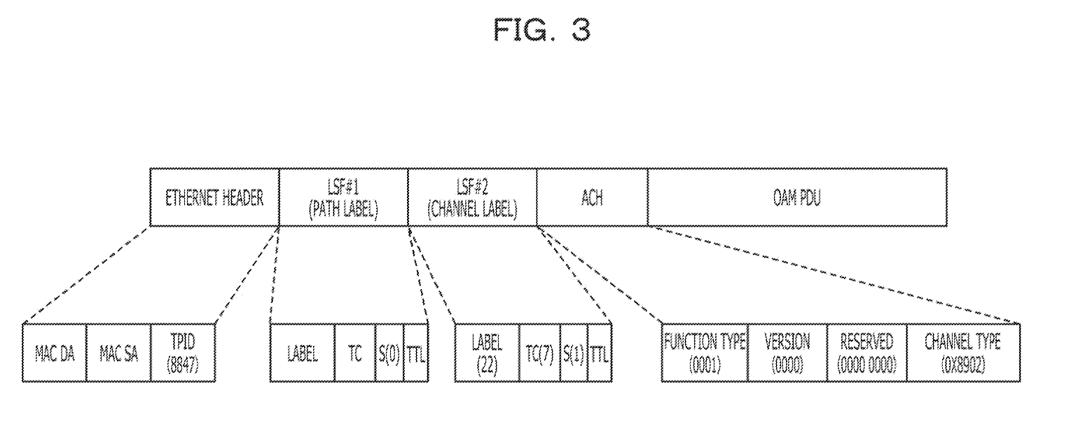

At this time, the frame of the path OAM that is transmitted and received between the termination node 200 and the termination node 300 will be described. FIG. 3 is a diagram illustrating an example of a path OAM format. As illustrated in FIG. 3, the frame of the path OAM includes “Ethernet® Header” as management information, “LSF#1” as a shim header indicating a path label, and “LSF#2” as a shim header indicating a channel label. As illustrated in FIG. 3, the frame of the path OAM includes “ACH” indicating a version of a frame and “OAM Protocol Data Unit (PDU)” as an area where data used in the OAM is set.

The Ethernet Header includes “Media Access Control (MAC) Destination Address (DA)” as a MAC address that is set to an interface of a transmission destination node. The Ethernet Header includes “MAC Source Address (SA)” as a MAC address that is set to the interface of the transmission destination node and “TPID (8847)” as an ID of a protocol.

The LSF#1 and the LSF#2 include a label, a “Time Code (TC)” indicating a time interval, an “S” field for identifying a shim header, and a “Time To Live (TTL)” indicating the existing period of the label, respectively. The ACH includes a “Function Type (0001),” a “Version (0000),” a “Reserved (0000 0000),” and a “Channel Type (0x8902)” of a frame.

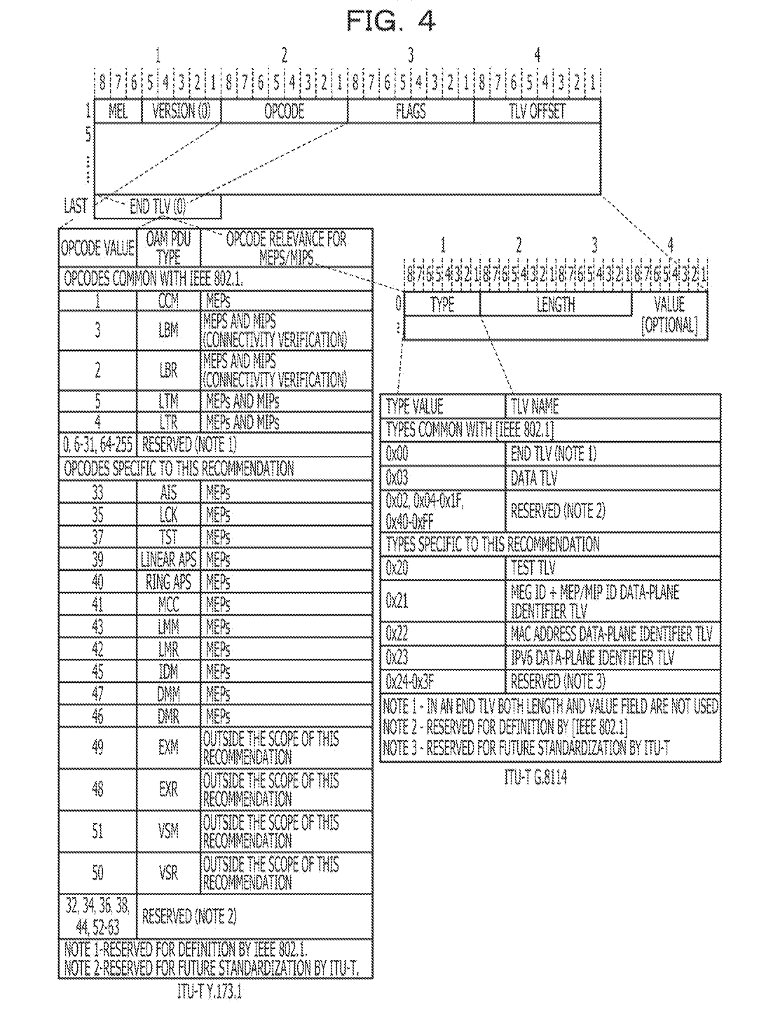

FIG. 4 is a diagram illustrating an example of the OAM PDU format. As illustrated in FIG. 4, the OAM PDU includes a fixed area in which “MEL” indicating the MEG level of a transmission source MEP, a “Version (0)” indicating version information of the frame, an “OpCode” indicating code information of the frame, and the like are set. The OpCode indicates a value by which the type of the OAM is associated with the node information related thereof. For example, “1 ” of “OpCode Value” indicated as “OpCode Value:1, OAM PDU Type:CCM, OpCode relevance for MEPs/MIPs” is set to the OpCode. Similarly, various OpCode Values are set depending on which function is the OAM of the frame is used by.

In addition to fixed areas such as the “MEL,” the “Version (0),” and the “OpCode,” the OAM PDU includes a Type Length Value (TLV) that is a variable area where various parameters are set. Type indicates a type of an item included in Value. Length indicates a length of Value. Value indicates a data part of a packet. For example, for the TLV, “0x00” of “Type Value” indicated as “Type Value:0x00, TLV Name:End TLV(Note 1)” is set. Similarly, for the TLV, various Type Values are set to the TLV depending on the parameter that is set to the frame.

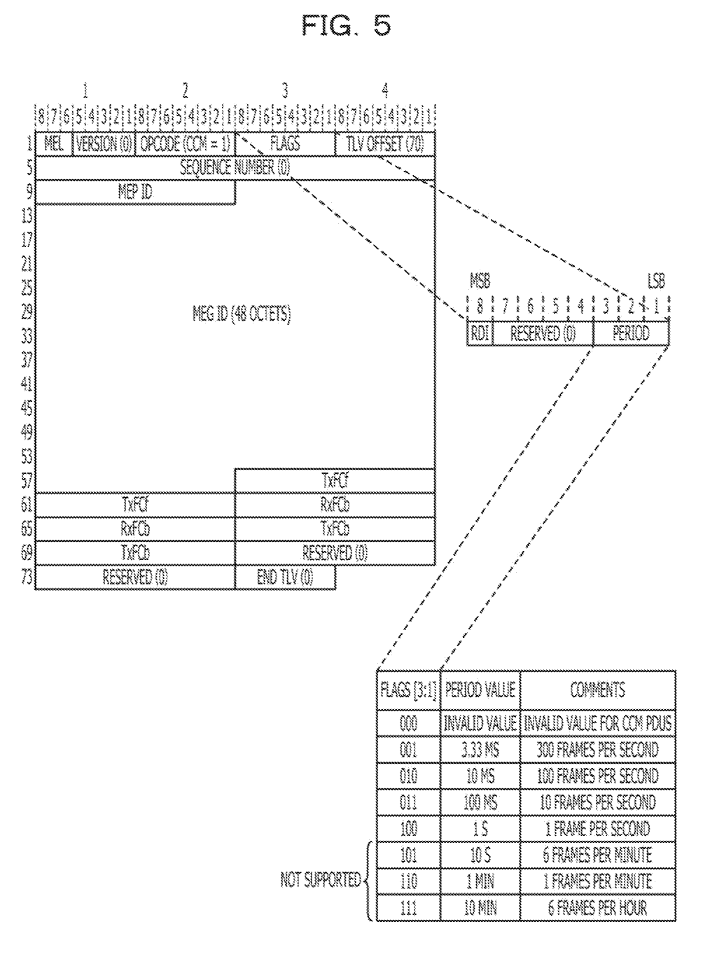

At this time, an example of the CCM frame is described with reference to FIG. 5. FIG. 5 is a diagram illustrating an example of the CCM OAM PDU format. For example, as illustrated in FIG. 5, for the OAM PDU of the CCM frame, “CCM=1” is set to the “OpCode.” The OAM PDU of the CCM frame includes a “Sequence number (0)” indicating a number for transmission, the “MEPID” of the transmission destination node, the “MEGID” assigned to the path, and the like. “Period” indicating a transmission reception interval of the CCM frame is set to “Flags” of the OAM PDU of the CCM frame. For example, “001” indicated as “Flags[3:1]:001, Period value:3.33 ms, Comments:300 frames per second” is set to the “Flags,”. In the above-described case, 300 frames are transmitted and received in one second. That is, 1 frame is transmitted and received in 3.3 milliseconds.

As illustrated in FIG. 2, for example, the termination node 200 sets “101” to the “Path Label” illustrated in FIG. 2 and transmits the CCM frame in which “2” is set to the “MEPID” illustrated in FIGS. 5 and “0001” is set to the “MEGID.” Similarly, the termination node 300 sets “202” to the “Path Label” illustrated in FIG. 2, and transmits the CCM frame in which “1” is set to the “MEPID and “0001” is set to the “MEGID” illustrated in FIG. 5.

As illustrated in FIG. 2, the relay node 100 replaces the label “101” attached to the frame transmitted from the termination node 200 with the label “102” and transmits the frame to the termination node 300. As illustrated in FIG. 2, the relay node 100 replaces the label “202,” which is attached to the frame transmitted from the termination node 300, with the label “201” and transmits the frame to the termination node 200. Processing of the relay node 100 will be described in a configuration of the relay node according to the second embodiment.

[Configuration of Relay Node According to Second Embodiment]

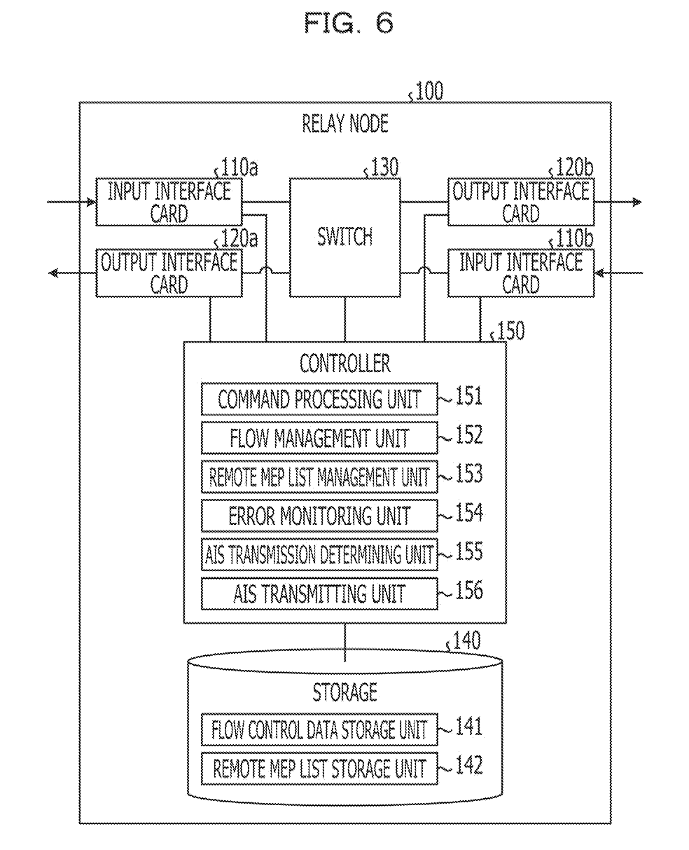

The configuration of the relay node according to the second embodiment will be described. FIG. 6 is a diagram illustrating the configuration of the relay node 100 according to the second embodiment. As illustrated in FIG. 6, the relay node 100 includes an input interface card 110a, an input interface card 110b, an output interface card 120a, an output interface card 120b, a switch 130, a storage 140, and a controller 150. The input interface cards 110a and 110b, the output interface cards 120a and 120b, the switch 130, and the controller 150 may have the following configuration, respectively. That is, for example, hardware using the ASIC, the FPGA, and the like may be used. The configuration may include the above-described hardware and hardware such as a CPU or a memory and may be controlled by a program.

The input interface card 110a controls an input of a frame that is transmitted from the termination node 200. The input interface card 110a monitors information included in the CCM frame transmitted from the termination node 200. Specifically, the input interface card 110a monitors the MEG level, the MEGID, the MEPID included in the CCM frame transmitted from the termination node 200.

The input interface card 110b controls the input of the frame transmitted from the termination node 300. The input interface card 110b monitors the information included in the CCM frame transmitted from the termination node 300. Specifically, the input interface card 110b monitors the MEG level, the MEGID, and the MEPID included in the CCM frame transmitted from the termination node 300.

The output interface card 120a controls transmission of the frame to the termination node 200 input from the switch 130 or the controller 150 described below. The output interface card 120b controls the transmission of the frame to the termination node 300 input from the switch 130 or the controller 150 described below.

The input interface card 110a and the output interface card 120a correspond to the slot 1-6 illustrated in FIG. 2. The input interface card 110b and the output interface card 120b correspond to the slot 1-5 illustrated in FIG. 2.

The switch 130 replaces the label of the frame input from the input interface card 110a with another label and then transfers the frame to an appropriate output interface card. For example, the switch 130 replaces the label “101,” which is attached to the CCM frame input from the input interface card 110a, with the label “102” and then transfers the CCM frame to the output interface card 120b. The switch 130 replaces the label of the frame input from the input interface card 110b with another label and then transfers the frame to an appropriate output interface card. For example, the switch 130 replaces the label “202,” which is attached to the CCM frame input from the input interface card 110b, with the label “201” and then transfers the frame to the output interface card 120a.

The storage 140 includes a flow control data storage 141 and a remote MEP list storage 142, and stores various data used by the relay node 100 and processing results from the controller 150 described below. The storage 140 may be, for example, a semiconductor memory such as a Random Access Memory (RAM), a Read Only Memory (ROM), or a Flash Memory, or may be a storage device such as a hard disk, or an optical disk.

The flow control data storage 141 stores flow control data as information for replacing the label attached to the frame that is input from the input interface card 110a and is output from the output interface card 120b. For example, the flow control data storage 141 stores information indicating that the label “101,” which is attached to the CCM frame input from the input interface card 110a is replaced, with the label “102.” Furthermore, the flow control data storage 141 stores the information, which is input from the input interface card 110b, for replacing the label attached to the frame output from the output interface card 120a. For example, the flow control data storage 141 stores the information indicating that the label “202,” which is attached to the CCM frame input from the input interface card 110b, with the label “201.”

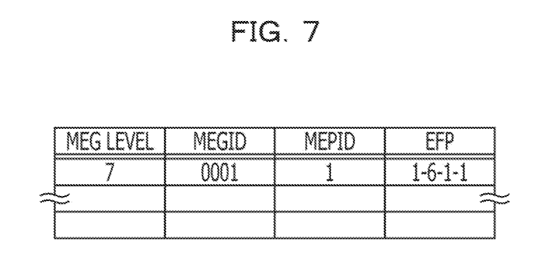

The remote MEP list storage 142 stores the remote MEP list generated by the controller 150 described below. Specifically, the remote MEP list storage 142 stores the remote MEP list that is used when the controller 150 generates an alarm frame after an error occurs on the network to which the relay node 100 is coupled. The alarm frame is an AIS, for example. FIG. 7 is a diagram illustrating the remote MEP list storage 142.

As illustrated in FIG. 7, the remote MEP list storage 142 stores the remote MEP list in which the MEG level, the MEGID, the MEPID, and the EFP are associated with each other. In this case, the “MEG level” indicates a management level that is set to the MEG. The “MEGID” indicates an identifier for uniquely identifying the set MEG. The “MEPID” indicates an identifier for uniquely identifying the MEP from which the alarm frame is transmitted. The “EFP” indicates a flow point on the outlet side of each node when the alarm frame is transmitted.

As illustrated in FIG. 7, for example, the remote MEP list storage 142 stores the remote MEP list in which “MEG leve1:7,”“MEGID:0001,” “MEPID:1,” and “EFP:1-6-1-1” are associated with each other.

As illustrated in FIG. 6, the controller 150 includes a command processing unit 151, a flow management unit 152, a remote MEP list management unit 153, an error monitoring unit 154, an AIS transmission determining unit 155, and an AIS transmitting unit 156. The controller 150 is, for example, an integrated circuit such as an Application Specific Integrated Circuit (ASIC) or a Field Programmable Gate Array (FPGA) or is an electric circuit such as a Central Processing Unit (CPU) or a Micro Processing Unit (MPU).

The command processing unit 151 executes a command that is input from an input unit (not illustrated) by the manager of the network that includes the relay node 100. For example, the command processing unit 151 stores the flow control data, which is set by the manager, in the flow control data storage 141. The flow management unit 152 manages input and output of the frame. Specifically, the flow management unit 152 generates a flow point as information of an outlet from which the relayed frame is output and stores, in the storage 140, a Transport Service Group (TSG) in which the generated flow point is associated with each path. For example, the flow management unit 152 generates and stores the TSG “MEGID:0001, flow point:1-5-1-1, flow point:1-6-1-1” in the storage 140.

The remote MEP list management unit 153 obtains the MEGID for identifying the MEG and the MEPID for identifying the MEP from the frame relayed through the switch 130. The remote MEP list management unit 153 uses the obtained MEGID and MEPID to generate a remote MEP list used to transmit the alarm signal and stores the generated remote MEP list in the remote MEP list storage 142.

The remote MEP list management unit 153 obtains first information that includes the MEGID from a first frame transmitted from one of the nodes from among the frames transmitted and received between the nodes as terminations. The remote MEP list management unit 153 obtains second information that includes the MEPID from a second frame transmitted from the other node.

The remote MEP list management unit 153 updates the remote MEP list if the MEGID or the MEPID corresponding to the remote MEP list stored by the remote MEP list storage 142 is changed to new information.

Specifically, the remote MEP list management unit 153 sets the MEG level included in the CCM frame, the MEGID, the EFP as the flow point of the outlet of the alarm frame to the remote MEP list on the outlet side of the input CCM frame. The remote MEP list management unit 153 sets the MEPID included in the CCM frame that is input into the remote MEP list of an inlet side of the input CCM frame. The remote MEP list management unit 153 stores the remote MEP list on the outlet side and the remote MEP list on the inlet side in the remote MEP list storage 142, respectively. Hereinafter, the outlet side may be referred to as Egress, and the inlet side may be referred to as Ingress.

For example, the remote MEP list management unit 153 sets “MEG level:7” and “MEGID:0001,” which are included in the CCM frame monitored by the input interface card 110a, to the remote MEP list of the outlet side “1-5-1-1.” The remote MEP list management unit 153 sets “EFP:1-6-1-1” to the remote MEP list of “1-5-1-1” on the outlet side of the CCM frame.

The remote MEP list management unit 153 sets “MEPID:2,” which is included in the CCM frame monitored by the input interface card 110a, to the remote MEP list of “1-6-1-1” on the inlet side of the CCM frame.

Similarly, the remote MEP list management unit 153 sets “MEG level:7” and “MEGID:0001,” which are included in the CCM frame monitored by the input interface card 110b, to the remote MEP list of the outlet side “1-6-1-1” of the frame. The remote MEP list management unit 153 sets “EFP:1-5-1-1” to the remote MEP list of “1-6-1-1” on the outlet side of the CCM frame.

The remote MEP list management unit 153 sets “MEPID:1,” which is included in the CCM frame monitored by the input interface card 110b, to the remote MEP list of “1-5-1-1” on the input side of the CCM frame.

That is, the remote MEP list management unit 153 generates one remote MEP list by using the CCM frame transmitted from both MEPs located in the termination of the MEG. The remote MEP list management unit 153 updates the remote MEP list if the information monitored by the input interface card 110a and the input interface card 110b are different from the information stored by the remote MEP list storage 142.

The error monitoring unit 154 monitors whether if an error occurs in each section. For example, if the CCM frame, which is transmitted and received to and from the section OAM, is not received in the predetermined period, the error monitoring unit 154 determines that an error occurs.

If the error monitoring unit 154 determines that the error occurs, the AIS transmission determining unit 155 determines whether or not the TSG, which includes the section in which the error occurs, is stored in the storage 140. If the TSG that includes the section in which the error occurs is stored in the storage 140, the AIS transmission determining unit 155 determines to transmit the alarm frame. For example, if the TSG that includes the section in which the error occurs is stored in the storage 140, the AIS transmission determining unit 155 determines to transmit the AIS.

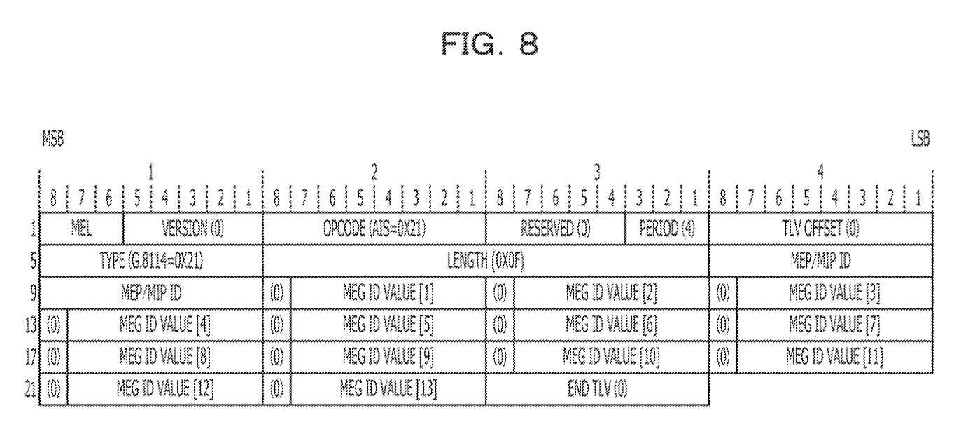

If the error occurs, based on the remote MEP list generated by the remote MEP list management unit 153, the AIS transmitting unit 156 generates an alarm signal and transmits the generated alarm signal. Specifically, if the AIS transmission determining unit 155 determines to transmit the alarm frame, the AIS transmitting unit 156 generates and transmits an alarm frame to the corresponding MEP. For example, if the AIS transmission determining unit 155 determines to transmit the AIS, the AIS transmitting unit 156 generates and transmits an AIS frame to the corresponding MEP. FIG. 8 is a diagram illustrating an example of the AIS OAM PDU frame.

As illustrated in FIG. 8, in the AIS frame, for example, “0x21” is set as the type value of the AIS to “OpCode” as the code information of the frame as illustrated in FIG. 8. Furthermore, as illustrated in FIG. 8, the OAM PDU of the AIS frame includes an area such as MEL by which the MEG level is set and MEP/MIPID in which the MEPID or the MIPID is set. For example, the AIS transmitting unit 156 sets various information to the AIS OAM PDU illustrated in FIG. 8 and transmits the set AIS frame to the corresponding MEP.

A procedure of the processing in the network that includes the relay node 100 according to the second embodiment and the procedure of the processing by the relay node 100 according to the second embodiment will be described. Firstly, the procedure of the processing in the network that includes the relay node 100 according to the second embodiment will be described. Secondly, the procedure of the processing by the relay node 100 according to the second embodiment will be described.

[Procedure of Processing in Network that Includes Relay Node According to Second Embodiment]

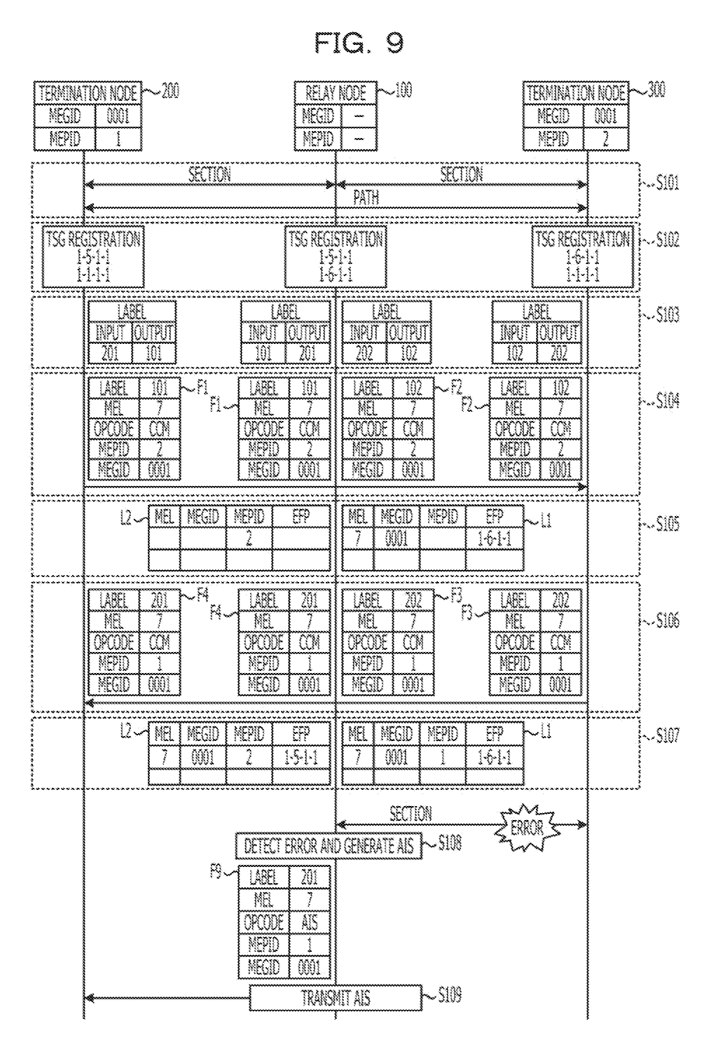

FIG. 9 is a sequence diagram illustrating the procedure of the processing in the network that includes the relay node according to the second embodiment. As illustrated in FIG. 9, in the network that includes the relay node 100 according to the second embodiment, a section is set between the termination 200 and the relay node 100 and between the relay node 100 and the termination node 300 (S101). If the manager provides the path between the termination node 200 and the termination node 300 (S101), the flow management unit 152 registers the TSG (S102). Specifically, when the path is provided, the flow management unit 152 generates a flow point as the information of the outlet, from which the relayed frame is output, and stores the TSG, by which the generated flow point is associated with each path, in the storage 140.

The flow management unit 152 associates the information related to label replacing stored by the flow control data storage 141 with the TSG (S103). For example, the flow management unit 152 associates “1-5-1-1” of the TSG with “Label input:202, Label output:102.” The above-described information indicates that the label of the frame input into the flow point “1-5-1-1” is “202,” and the label of the frame output from the flow point “1-5-1-1” is “102.” Similarly, the flow management unit 152 associates each flow point with the information related to the label replacing.

If the termination node 200 transmits the CCM frame of the path OAM, the relay node 100 replaces the label of the frame input from the flow point 1-6-1-1 with another label and transmits the frame from the flow point 1-5-1-1 (S104). For example, the termination node 200 transmits the CCM frame F1 of “Label:101, MEL:7, OpCode:CCM, MEPID:2, MEGID:0001” to the termination node 300.

The relay node 100 transfers the frame F2 of which “Label:101” indicated in the frame F1 with “Label:102.” After receiving the frame F2, the termination node 300 checks if the coupling with the termination node 200 is maintained. The above-described “MEL” indicates the MEG level.

At this time, the relay node 100 generates remote MEP lists L1 and L2 by using the CCM frame F1 received from the termination node 200 (S105). Specifically, the input interface card 110a monitors and reports the information included in the input frame F1 to the remote MEP list management unit 153. The remote MEP list management unit 153 generates the remote MEP lists L1 and L2 by using the reported information.

For example, the remote MEP list management unit 153 sets “MEL:7” and “MEGID:0001” included in the frame F1, which is monitored by the input interface card 110a, to the remote MEP list L1 of “1-5-1-1” on the outlet side of the frame. The remote MEP list management unit 153 sets “EFP:1-6-1-1” to the remote MEP list L1 of “1-5-1-1” on the outlet side of the frame.

The remote MEP list management unit 153 sets “MEPID:2” included in the frame F1 monitored by the input interface card 110a to the remote MEP list L2 of “1-6-1-1” on the inlet side of the frame.

After that, when the termination node 300 transmits the CCM frame of the path OAM, the relay node 100 replaces the label of the frame input from the flow point 1-5-1-1 with another label and transmits the frame from the flow point 1-6-1-1 (S106). For example, the termination node 200 transmits the CCM frame F3 of “Label:202, MEL:7, OpCode:CCM, MEPID:1, MEGID:0001” to the termination node 200.

The relay node 100 transfers the frame F4 in which “Label:202” indicated in the frame F3 is replaced with “Label:201” to the termination node 200. After receiving the frame F4, the termination node 200 checks if the coupling with the termination node 300 is maintained.

The relay node 100 generates the remote MEP lists L1 and L2 by using the CCM frame F3 received from the termination node 300 (S107). Specifically, the input interface 110b monitors and reports the information included in the input frame F3 to the remote MEP list management unit 153. The remote MEP list management 153 generates the remote MEP lists L1 and L2 by using the reported information.

For example, the remote MEP list management unit 153 sets “MEL:7” and “MEGID:0001,” which are included in the frame F3 monitored by the input interface card 110b, to the remote MEP list L2 of “1-6-1-1” on the outlet side of the frame. The remote MEP list management unit 153 sets “EFP:1-5-1-1” to the remote MEP list L2 of “1-6-1-1” on the outlet side of the frame.

The remote MEP list management unit 153 sets “MEPID:1,” which is included in the frame F3 monitored by the input interface card 110b, to the remote MEP list L1 of “1-5-1-1” on the inlet side of the frame. As described above, the relay node 100 autonomously generates the remote MEP list by using the CCM frame transmitted from the both MEPs located in the termination of the MEG.

After the remote MEP list is generated, the relay node 100 generates the alarm frame by referring to the generated remote MEP list if the error occurs in the network. For example, if the error occurs in the section between the relay node 100 and the termination node 300, the relay node 100 detects the error in the section and generates an AIS (S108).

Specifically, if the error monitoring unit 154 detects an error in the section, the AIS transmission determining unit 155 determines to transmit the AIS to the termination node 200. With reference to the remote MEP list L1, the AIS transmitting unit 156 generates and transmits the AIS frame F5 of “Label:201, MEL:7, OpCode:AIS, MEPID:1, MEGID:0001” to the termination node 200 (S109).

In the procedure of the above-described processing, a case where the termination node 200 transmits the CCM frame earlier is described above. However, the embodiments are not limited to the above-described case. For example, the termination node 300 may transmit the CCM frame earlier. Furthermore, the termination node 200 and the termination node 300 may transmit the CCM frame at the same time.

[Procedure of Generating Processing of Remote MEP List by Relay Node According to Second Embodiment]

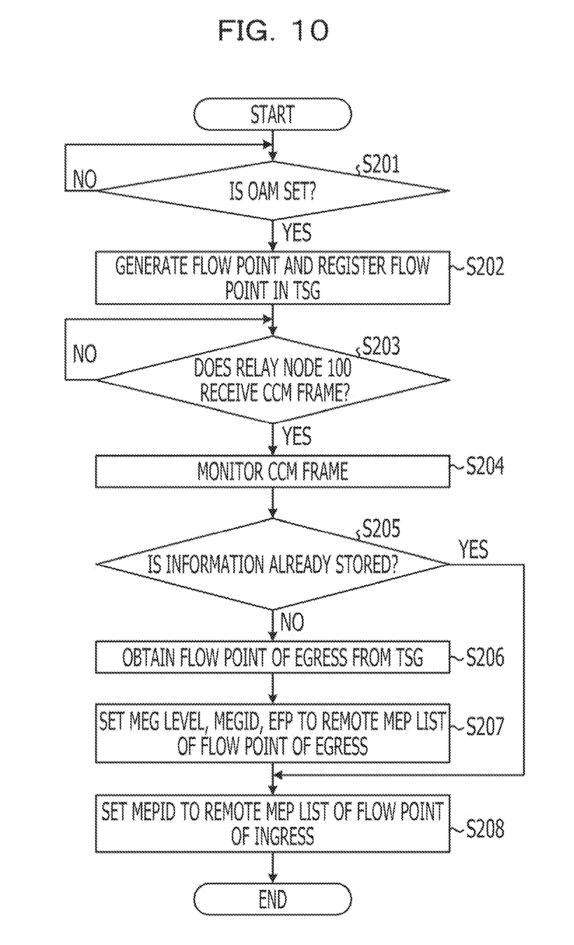

FIG. 10 is a diagram illustrating the procedure of the generating processing of the remote MEP list by the relay node 100 according to the second embodiment. As illustrated in FIG. 10, in the relay node 100 according to the second embodiment, if the path OAM is provided, the flow management unit 152 generates a flow point and registers the flow point in the TSG (S202).

If the relay node 100 receives the CCM frame (YES in S203), the input interface card 110a or the input interface card 110b monitors the CCM frame (S204) and then determines whether or not the information is already stored (S205). If the information is already stored (YES in S205), the relay node 100 ends the process.

On the other hand, if the information is not stored (NO in S205), the remote MEP list management unit 153 obtains the flow point of Egress from the TSG (S206). The remote MEP list management unit 153 sets the MEG level, the MEGID, and the EFP to the remote MEP list of the flow point of Egress (S207). The remote MEP list management unit 153 sets the MEPID to the remote MEP list of the flow point of Ingress (S208) and then ends the process. If the relay node 100 does not receive the CCM frame (NO in S203), the relay node 100 is in a standby state.

[Procedure of Transmitting Processing of AIS by Relay Node According to Second Embodiment]

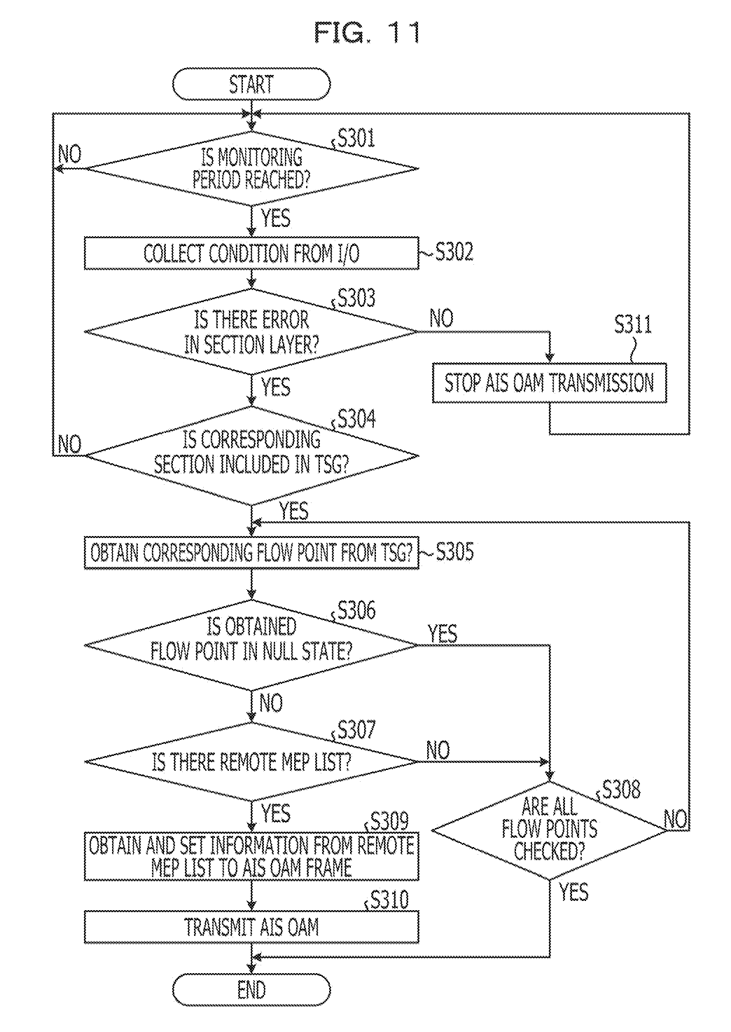

FIG. 11 is a diagram illustrating the procedure of the transmitting processing of the AIS by the relay node 100 according to the second embodiment. As illustrated in FIG. 11, regarding the relay node 100 according to the second embodiment, if a monitoring period is reached, the error monitoring unit 154 collects conditions from an I (Input)/O (Output) (S302). The error monitoring unit 154 determines whether or not the error occurs in a section layer (S303).

If the error monitoring unit 154 determines that the error occurs (YES in S303), the AIS transmission determining unit 155 determines whether or not the corresponding section is included in the TSG (S304). If the AIS transmission determining unit 155 determines that the corresponding section is included in the TSG (YES in S304), the AIS transmission determining unit 155 obtains the corresponding flow point from the TSG (S305). The AIS transmission determining unit 155 determines whether or not the obtained flow point is in a null state (S306).

If the AIS transmission determining unit 155 determines that the obtained flow point is not in the null state (NO in S306), the AIS transmitting unit 156 determines whether or not there is the remote MEP list (S307). If the AIS transmitting unit 156 determines that there is the remote MEP list (YES in S307), the AIS transmitting unit 156 obtains information from the remote MEP list and then sets the information to the AIS OAM frame (S309). The AIS transmitting unit 156 transmits the AIS OAM frame (S310) and then ends the process.

If the section in which the error occurs is not included in the TSG (NO in S304), the process goes back to S301. If no error occurs in the section layer (NO in S303), the AIS transmitting unit 156 stops transmitting the AIS OAM frame , and the process goes back to S301. The relay node 100 determines whether or not the monitoring period is reached. If the monitoring period is not reached (NO in S301), the relay node 100 is in the standby state.

If the AIS transmission determining unit 155 determines that the obtained flow point is in the null state (YES in S306) or if there is not the remote MEP list (NO in S307), the AIS transmission determining unit 155 determines whether or not all the flow points are checked (S308). If all the flow points are not checked (NO in S308), the process goes back to S305. The AIS transmission determining unit 155 obtains the corresponding flow point from the TSG. On the other hand, if all the flow points are checked (YES in S308), the relay node 100 ends the process.

[Effect of Second Embodiment]

As described above, according to the second embodiment, the switch 130 relays the CCM frame that is transmitted and received between the nodes as the termination of the path. The remote MEP list management unit 153 obtains the MEGID for identifying the MEG and the MEPID for identifying the MEP from the CCM frame that is relayed by the switch 130. The remote MEP list management unit 153 generates the remote MEP list by using the obtained MEGID and the MEPID. If the error occurs, the AIS transmitting unit 156 generates the alarm signal based on the remote MEP list generated by the remote MEP list management unit 153 and then transmits the generated alarm signal. Therefore, the relay node 100 according to the second embodiment is not set by the manager of the network and may autonomously generate the control information that is used to transmit the alarm signal. As a result, the relay node 100 according to the second embodiment may reduce the load of the operation setting on the manager of the network.

By autonomously generating the control information that is used to transmit the alarm signal, the relay node 100 according to the second embodiment may shorten the time desired by the manager for operation setting of the network, so that the service may be provided immediately.

According to the second embodiment, the remote MEP list storage 142 stores the remote MEP list generated by the remote MEP list management unit 153. If the MEGID or MEPID corresponding to the remote MEP list stored in the remote MEP list storage 142 is changed to the new information, the remote MEP list management unit 153 updates the remote MEP list. Therefore, the relay node 100 according to the second embodiment may reduce the load on the device that generates the remote MEP list.

According to the second embodiment, the remote MEP list management unit 153 obtains first information that includes the MEGID from a first frame transmitted from one of the nodes from among the CCM frames transmitted and received to and from the nodes as the termination. The remote MEP list management unit 153 obtains second information included in the MEPID from the second frame transmitted from the other node. As a result, the relay node 100 according to the second embodiment may obtain appropriate information.

[Third Embodiment]

The first and second embodiments have been described above. Various forms except the above-described first and second embodiments are applicable. Various embodiments will be described in the following sections (1) to (3).

(1) Remote MEP list

In the second embodiment, description is made of a case where one remote MEP list is generated by using the CCM frame transmitted from the both MEPs located in the termination of the MEG. However, the embodiments are not limited to the above-described case. For example, the remote MEP list may be generated from the CCM frame transmitted from one of the MEGs.

(2) System Configuration and the Like

The specific mode of dispersion/combination of the devices is not limited to the diagram. The entire or part of the devices may be functionally or physically dispersed/combined in an arbitrary unit according to each load and utilization condition. For example, the AIS transmission determining unit 155 and the AIS transmitting unit 156 illustrated in FIG. 6 are combined together to be one controller. On the other hand, the remote MEP list storage 142 illustrated in FIG. 6 may be separated into an outlet side remote MEP list storage, which stores the remote MEP list on the outlet side, and an inlet side remote MEP list, which stores the remote MEP list on the inlet side.

(3) Control Information Generation Program

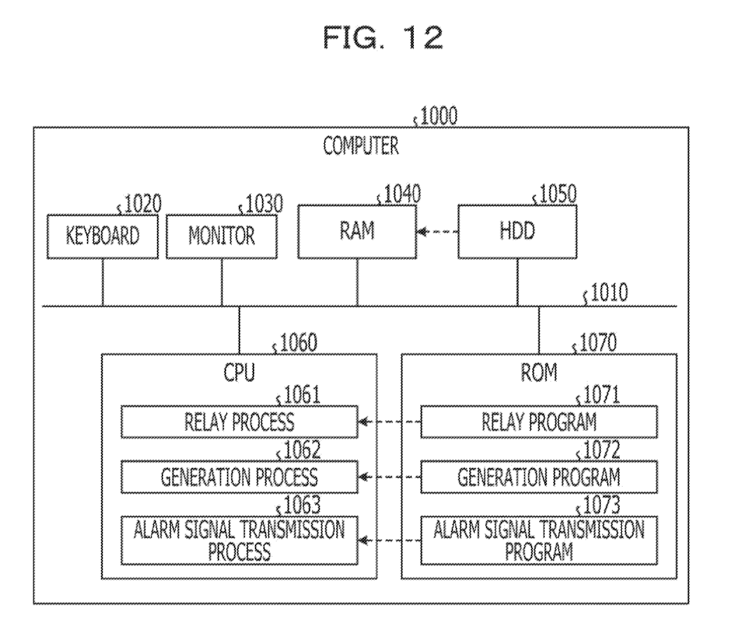

In the first embodiment, a case where each processing is achieved by hardware logic has been described. However, the embodiments are not limited to the above-described case. The programs that are previously prepared may be executed by a computer. With reference to FIG. 12, an example of the computer that executes the control information generation program that has the similar function as the relay device 1 described in the first embodiment will be described. FIG. 12 is a diagram illustrating the computer that executes the control information generation program.

As illustrated in FIG. 12, a computer 1000 as an information processing device includes a keyboard 1020, a monitor 1030, a RAM 1040, an HDD 1050, a CPU 1060, and a ROM 1070. The keyboard 1020, the monitor 1030, the RAM 1040, the HDD 1050, the CPU 1060, and the ROM 1070 are coupled with each other by a bus 1010 or the like.

The ROM 1070 previously stores a control information generation program that has the similar function as the relay device 1 illustrated in the above-described first embodiment, that is, a relay program 1071, a generation program 1072 as illustrated in FIG. 12. The ROM 1070 previously stores an alarm signal transmission program 1073. The programs 1071 to 1073 may be combined or dispersed in the similar way to the components of the relay device 1 illustrated in FIG. 1.

By being read out from the ROM 1070 and executed by the CPU 1060, the programs 1071 to 1073 function as the processes illustrated in FIG. 12. That is, a relay process 1061, a generation process 1062, an alarm signal transmission process 1063 function. Each of the processes 1061 to 1063 corresponds to the frame relay unit 2, the control information generating unit 3, the alarm signal transmitting unit 4 illustrated in FIG. 1, respectively.

The above-described programs 1071 to 1073 are not always desired to be stored in the ROM 1070 from the beginning. The programs 1071 to 1073 may be stored in another storage medium or another storage device, and the computer 1000 may read out the programs from the storage medium or the storage device and executes the programs. The storage medium and the storage device may be, for example, a “potable physical medium” such as a flexible disk to be inserted into the computer 1000, a CD-ROM, a MO disk, a DVD disk, an optical magnetic disk, an IC card, or the like. Furthermore, the storage medium and the storage device is, for example, a “fixed physical medium” such as an HDD provided inside the computer 1000 or provided outside the computer 1000. The other storage medium and the storage device is “another computer (server)” that is coupled to the computer 1000 through a public line, the Internet, LAN, WAN, or the like.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A relay device comprising:
a relay to relay a frame transmitted and received between transmission devices as a termination of a transferring path of a piece of data;
an information generator to obtain a piece of path identification information for identifying the transferring path and a piece of device identification information for identifying the transmission device and generate a piece of control information based on the obtained piece of path identification information and the piece of device identification information; and
an alarm signal transmitter to generate an alarm signal based on the control information generated by the information generator when an error occurs in the transferring path and transmit the generated alarm signal.

2. The relay device according to claim 1, further comprising a storage to store the control information generated by the generating unit, and
wherein the information generator updates the control information stored in the storage when the path identification information or the device identification information corresponding to the control information stored in the storage is changed to a new piece of information.

3. The relay device according to claim 1, wherein, from among the frames transmitted and received between the transmission devices as the termination, the information generator obtains a first piece of information which includes the path identification information from a first frame transmitted from one of the transmission devices, and
wherein the information generator obtains a second piece of information which includes the device identification information from a second frame transmitted from the other transmission device.

4. A control information generating method comprising:
relaying a frame which is transmitted and received between transmission devices as a termination in a transferring path of a piece of data;
obtaining a piece of path identification information for identifying the transferring path and a piece of device identification information for identifying the transmission device from the frame;
generating a piece of control information based on the obtained path identification information and the obtained device identification information.

5. A computer-readable medium including program instructions for performing, when executed by a processor, a control information generation method, the method comprising:
relaying a frame transmitted and received between transmission devices as a termination in a transferring path of a piece of data;
obtaining a piece of path identification information for identifying the transferring path and a piece of device identification information identifying a transmission device from a relay;
generating a piece of control information based on the obtained path identification information and the obtained device identification information; and
generating an alarm signal based on the control information generated by the generating process to transmit the generated alarm signal when an error occurs in the transferring path.
